(19) United States
(12) Patent Application Publication
(10) Pub. No.: US 2025/0388772 A1
(43) Pub. Date: Dec. 25, 2025

(54) NATURAL INGREDIENT EXTERIOR WOOD PRIMER PAINT COMPOSITION

(71) Applicant: David L Smith, Vancouver, WA (US)

(72) Inventor: David L Smith, Vancouver, WA (US)

(21) Appl. No.: 18/750,031

(22) Filed: Jun. 21, 2024

(51) Int. Cl. C09D 15/00; C09D 5/00; C09D 7/20; C09D 191/00

(52) U.S. Cl. CPC C09D 15/00; C09D 5/002; C09D 7/20; C09D 191/00

(57) ABSTRACT

An exterior weathered or aged wood paint primer includes all-natural components such as organic natural glues, natural paint binders that penetrate wood, soap made from natural ethanol and vegetable oil for improved surfactant penetration and particulate wood matter adherence with the rosin. The exterior paint formula provides a better substrate on weathered or aged wood for the final paint coat to adhere to so less repeat painting in the following years is indicated because there is less adhesion failure.

### BACKGROUND

### Technical Field

This disclosure relates to paint compositions. In particular, the disclosure relates to, but is not limited to, an all-natural ingredient exterior wood primer paint composition.

Primer compositions are known in the art.

U.S. Pat. No. 4,094,837 describes a corrosion inhibiting primer paint for hand cleaned ferrous metals.

U.S. 2011/0200817 describes a primer coating for use on substrates.

U.S. 2009/0142282 describes high-solids alcoholic solutions of rosin esters for varnish applications.

Wood is the natural structural fibrous tissue harvested from live trees. It is the main building material when dwellings are constructed. As a natural but dead organic material, it has a limited “lifespan”, depending on the level of maintenance. Paint have been used for thousands of years to beautify and increase the longevity of wood-based products. During the last half century, manufactured synthetic “water-based” paints have largely replaced “oil-based” paints to reduce volatile organic compounds (VOCs) that were present when previous solvents (e.g., turpentine) were used as thinning vehicles for applying exterior wood oil-based paints.

Most wood siding for dwellings typically originates from conifers. Typical conifer wood siding is cedar or pine. Cedar or pine, previously harvested 150 years ago had a much tighter annual ring structure reflecting a cooler shortened yearly growth period with better longevity. Cedar or pine siding currently available is a soft wood fiber largely harvested from tree farms that consists of extracellular material manufactured by wood cells made up primarily of cellulose, pectin and lignin. Cellulose is a sugar-based polymer that adds strength as trees grow upward. Pectin is a different complex polysaccharide facilitating intercellular adhesion and wall hydration. Lignin is a hydrophobic three-dimensional amorphous branched phenolic polymer which cements cellulose and pectin together which allows flexibility, increased intercellular physical firmness and limits microbiological degradation and oxidation. These three constituents essentially form natural wood fiber. Of equal chemical importance in conifer-originated wood are oil-based resins which are transported in ducts around wood fibers and functionally serve as an antimicrobial and insecticide upon attempted tree wound pathogen invasion while decreasing wood decay.

Once harvested from conifer trees, cedar or pine siding planks can last over a century with scheduled paint or other film coating maintenance. Without paint or coating film, wood siding may only last 15 years. Increased rate of wood fiber physical degradation or “weathering” occurs related to solar irradiation, temperature extremes, particulate matter exposure, algal, mold, fungi and insect degradation. Excess hydration and resultant wood fiber swelling can also occur when natural oils gradually evaporate or are leached from wood siding upon prolonged water exposure. Resultant wood fiber premature degradation coupled with loss of natural protective oils are the prime factors for exterior cedar or pine wood plank siding weathering.

In large part, water-based paint acts as a wood surface barrier coating. The protective attribute of paint on aged wood most commonly fails from incomplete wood surface preparation (e.g., incomplete removal of loose debris), poor adhesion of paint to the underlying wood painted surface substate or seasonal variation of wood fiber moisture content. The seasonal swelling and contraction gradually reduce primer paint film adhesion. Synthetic primer paints currently available don't penetrate wood, become inflexible and are limited to surface adhesion binding. Increased amounts of synthetic cementing agents or binding adhesives are employed in attempt to increase primer paint film bonding to underlying painted or bare wood surface. Therefore, premature failures from paint cracking, blistering and peeling are common outcomes of synthetic primer or other paint finishes applied to aged wood.

Moreover, paint emulsion essential ingredients do not prevent fungal, mildew or algal decay. Also, unlike natural adhesives, synthetic binding or gluing resins are not biodegradable.

Therefore, a need exists for an all-natural wood primer paint composition to improve weathered wood adherence with improved surfactant-wood penetration. Based on currently available alkyd, acrylic, or other water-soluble primer paint coatings' lack of wood penetration and nonbiodegradable synthetic adhesive ingredients coupled with premature paint adhesion failure, a unique primer paint formulation is invented.

An environmentally friendly, novel, all-natural paint primer with distinct wood penetration characteristics utilizing naturally solubilized anchoring rosin-based molecules (e.g., abietates or other resinates) with no paint binder VOCs is presented where long chain fatty acids are cleaved from glycerol to form soaps to enhance wood fiber diffusion. Therefore, rather than a synthetic emulsion, where a paint film is surface bound, this invention is an improved paint primer formulation to increase wood subsurface penetration and wood fiber 11 molecular anchoring. Moreover, the natural resins and fatty acids within the formulation act as antibacterial and antimicrobial agents.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

In an aspect of the disclose a primer paint composition is disclosed. The primer paint composition may include a rosin glue; a linseed or hemp oil binder; an alcohol; a natural oil; and a catalyst to esterify a fatty acid component of the natural oil and form a rosin acid-based salt.

In an aspect of the disclosure, a method to apply a primer paint to a wood surface is disclosed. In an aspect, a primer paint composition is provided. The primer paint composition may include a rosin glue; a linseed oil binder; a hemp oil binder, an alcohol; a natural oil; and a catalyst to esterify a fatty acid component of the natural oil. In an aspect, the paint composition is applied to the wood surface. 2

Other systems, methods, features and advantages of the invention will be, or will become apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates a flowchart 100 of acts taken to prepare a primer paint, according to an aspect of the disclosure.

### DETAILED DESCRIPTION

In conventional art, most if not all of paint primers for outside structures that have weathered wood use water-based (latex) or alkyd-based paint which are not natural and contain man-made binders or resins as glue and they do not penetrate wood. These for the most part form “skins” on wood for protection.

An advantage of the disclosed paint primer composition is that it includes all-natural components or ingredients to reduce pollution impact and reduced volatile organic compound residue in the ambient air. In addition, the disclosed paint composition can be applied onto damp wood with good penetration.

Moreover, with the disclosed paint composition, a superior wood penetration and improved adhesion with the final paint coat can be achieved because the disclosed wood substrate primer paint has a rosin that penetrates the weathered wood and an ethanol hydroxide-based soap that is brushed, rolled, sprayed or otherwise applied on, in the paint composition in order to effect enhanced wood penetration and facilitate adhesion.

In an aspect of the disclosure, a primer paint composition is disclosed. The primer paint composition may include a solution of components. The component may include a rosin glue. In an aspect, the rosin glue may include at least one of the following: abietic acid, neoabietic acid, palustric acid, pimaric acid, or isopimaric acid.

In an aspect of the disclosure, the components may include a linseed oil binder. In an aspect of the disclosure, the components may include an alcohol. In an aspect, the alcohol may include ethanol, though other alcohols may be used as known to one of skill in the art to prepare the paint primer composition.

In an aspect of the disclosure, the components may include a hemp oil binder. In an aspect of the disclosure, the components may include an alcohol. In an aspect, the alcohol may include ethanol, though other alcohols may be used as known to one of skill in the art to prepare the paint primer composition.

In an aspect of the disclosure, the components may include a natural oil. In an aspect, the natural oil may include at least one of the following: vegetable oil, safflower oil, canola oil, coconut oil, corn oil, olive oil, avocado oil, jojoba oil, shea butter, tea tree oil, peppermint oil, chamomile oil, marula oil, argan oil, grapeseed oil, rosehip oil, rosemary oil, castor oil, neats-foot oil, poppyseed oil, chia seed oil, borage seed oil, soybean, hazelnut, perilla, walnut, rosemary or oregano oil.

In an aspect of the disclosure, the components may include a catalyst to esterify a fatty acid component of the linseed, hemp or natural oil. In an aspect, the catalyst may include potassium hydroxide or other hydroxide to serve as a catalyst to esterify the fatty acid component of the natural oil. In an aspect, the fatty acid component may include at least one of the following: linoleic acid, linolenic acid, oleic acid, lauric acid, myristic acid, palmitic acid, ricinoleic or stearic acid.

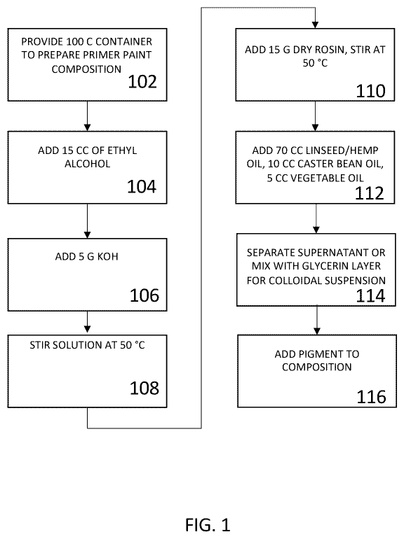

FIG. 1 illustrates a flowchart 100 of acts taken to prepare a primer paint composition, according to an aspect of the disclosure. At act 102, a 100 cc container is provided and prepared for accepting components of the primer paint composition.

At act 104, 15 cc of ethyl alcohol are added to the container. At act 106, 5 g of 29 potassium hydroxide (KOH) is added to the container.

At act 108, the solution is stirred at 50 degrees C. until the solution is mixed thoroughly. At act 110, 15 g of dry rosin is added and the solution is stirred at 50 degrees C. until the solution is thoroughly mixed and a pH of 12 is obtained in the solution.

At act 112, 70 cc of linseed and/or hemp seed oil is added along with 10 cc caster bean oil and 5 cc of other vegetable oil is added to the solution. At act 114, the solution is mixed for 15 minutes and then set aside for 24 hours.

At act 114, the resulting supernatant primer paint lying above the resulting glycerin layer is separated from the glycerin layer. In an aspect, the supernatant primer paint is mixed with the glycerin to form a colloidal suspension of pH 8.5. The resultant mixture is composed of soap-based surfactants and rosins in solution.

At act 116, pigment is added to the solution to form a paint of desired color to be applied to a surface.

As described above, the primer paint composition may include a rosin glue; a linseed or hemp oil binder; an alcohol; a natural oil; and a catalyst to esterify a fatty acid component of the natural oil.

In an aspect, the natural oil comprises at least one of the following: vegetable oil, safflower oil, canola coconut oil, corn oil, olive oil, avocado oil, jojoba oil, shea butter, tea tree oil, peppermint oil, chamomile oil, marula oil, argan oil, grapeseed oil, rosehip oil, rosemary oil, castor oil, neats-foot oil poppyseed oil, chia seed oil, borage seed oil, soybean, 16 hazelnut, perilla, walnut, rosemary or oregano oil.

In an aspect, the rosin glue comprises at least one of the following: abietic acid, neoabietic acid, palustric acid, pimaric acid, or isopimaric acid.

In an aspect, the catalyst comprises potassium hydroxide.

In an aspect, the fatty acid component comprises at least one of the following: linoleic acid, linolenic acid, oleic acid, lauric acid, myristic acid, palmitic acid, ricinoleic or stearic acid.

In an aspect, the alcohol comprises ethanol.

With potassium hydroxide dissolved in ethanol to form a “lye” or high pH solution and vegetable oil is added, an ethanol hydroxide-based soap is formed. The potassium hydroxide/ethanol combination is novel for oil-based primer paints. It is very useful as a surfactant to increase gum rosin (natural glue) in solution penetration into the “substrate” wood. With increased wood penetration, improved adhesion to the wood fibers or to surface area exposure is the result. Use of ethanol hydroxide-based soap is novel in paints. The overall liquid paint formation is a solution or can be formulated to a colloidal suspension if coloring pigments are dispersed in it.

Therefore, there is an enhanced primer paint natural glue penetration into the wood and the “top or finish coat” of paint also has better adhesion or bonding to the “painted wood/wood” substrate. A more durable finished paint on aged or weathered wood is the result.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A primer paint composition comprising a solution, colloidal suspension or dispersion of;
a rosin glue;
a linseed oil or hemp seed oil binder;
an alcohol;
a natural oil; and
a catalyst to esterify a fatty acid component of the natural oil, binder or rosin component.

2. The composition of claim 1, where the natural oil comprises at least one of the following: vegetable oil, safflower oil, canola oil, coconut oil, corn oil, olive oil, avocado oil, jojoba oil, shea butter, tea tree oil, peppermint oil, chamomile oil, marula oil, argan oil, grapeseed oil, rosehip oil, rosemary oil, castor oil, neats-foot oil poppyseed oil, chia seed oil, borage seed oil, soybean, hazelnut, perilla, walnut, rosemary or oregano oil.

3. The composition of claim 1, where the rosin glue comprises at least one of the following: abietic acid, neoabietic acid, palustric acid, pimaric acid, or isopimaric acid.

4. The composition of claim 1, where the catalyst comprises potassium hydroxide.

5. The composition of claim 1, where the fatty acid component comprises at least one of the following: linoleic acid, linolenic acid, oleic acid, lauric acid, myristic acid, palmitic acid, ricinoleic or stearic acid.

6. The composition of claim 1, where the alcohol comprises ethanol.

7. A primer paint composition comprising a solution of:
a glue component;
a binder;
a penetrating solvent;
a natural oil to bind with the penetrating solvent to form a soap; and
a hydroxide compound to esterify a fatty acid component of the natural oil.

8. The paint composition of claim 7, where the natural oil comprises at least one of the following: vegetable oil, safflower oil, canola oil, coconut oil, corn oil, olive oil, avocado oil, jojoba oil, shea butter, tea tree oil, peppermint oil, chamomile oil, marula oil, argan oil, grapeseed oil, rosehip oil, castor bean oil, neats-foot oil, poppyseed oil, chia seed oil, borage seed oil, soybean, hazelnut, perilla, walnut, rosemary oil, or oregano oil.

9. The paint composition of claim 7, where the rosin glue comprises at least one of the following: abietic acid, neoabietic acid, palustric acid, pimaric acid, or isopimaric acid.

10. The paint composition of claim 7, where the hydroxide compound comprises potassium hydroxide.

11. The paint composition of claim 7, where the fatty acid component comprises at least one of the following: linoleic acid, linolenic acid, oleic acid, lauric acid, myristic acid, palmitic acid or stearic acid.

12. The paint composition of claim 7, where the penetrating solvent comprises ethanol.

13. The paint composition of claim 7, where the glue component comprises a rosin glue.

14. A method for preparing a primer paint composition, the method comprising:
adding 15 cc of ethyl alcohol to a 100 cc container;
adding 5 g of potassium hydroxide to the container;
stirring the ethyl alcohol and potassium hydroxide at 50° C. until thoroughly mixed;
adding 15 g of dry rosin to the container;
stirring at 50° C. until thoroughly mixed;
adding 70 cc or linseed oil and/or hemp seed oil, 10 cc caster bean oil and 5 cc of a different vegetable oil;
mixing for 15 minutes;
setting the container aside for 24 hours;
after at least approximately 24 hours, separating a supernatant from an underlying glycerin layer; and
adding a pigment to the supernatant to form a paint composition.

15. The method of claim 15. further comprising mixing the supernatant with the glycerin layer to form a colloidal suspension instead of separating the supernatant.
